(19) United States
(12) Patent Application Publication
(10) Pub. No.: US 2015/0371228 A1
(43) Pub. Date: Dec. 24, 2015

(54) METHOD OF GENERATING AND VALIDATING A VOUCHER THAT IS USED TO ENABLE AN END-USER TO OBTAIN GOODS OR SERVICES

(71) Applicant: CORETHREE LIMITED, Hertfordshire (GB)

(72) Inventors: Richard KERSHAW, Hertfordshire (GB); Michael SMITH, Hertfordshire (GB); James MURDOCH, Hertfordshire (GB)

(21) Appl. No.: 14/761,437

(22) PCT Filed: Jan. 20, 2014
(86) PCT No.: PCT/GB2014/050149

§ 371 Date: Jul. 16, 2015

(30) Foreign Application Priority Data
Jan. 18, 2013 (GB) 1300939.4

(51) Int. Cl. G06Q 20/40; H04L 9/14

(52) U.S. Cl. CPC G06Q 20/401; H04L 9/14; G06Q 2220/12; H04L 2209/24

(57) ABSTRACT

A method of generating and validating a voucher to enable an end-user to obtain goods or services, comprising: (a) generating or acquiring contextual data that describes the goods or services and then encrypting that contextual data at a server or other device; (b) generating a time code corresponding to a span of time during which the voucher is valid and including or concatenating that time code with the contextual data; (c) signing the contextual data and time code cryptographically using either a symmetric or asymmetric secret key or keys to generate a signature; (d) providing the contextual data and time code and/or the signature on a voucher; (e) validating the voucher offline at a validating system, without having on-line access by means of comparing the signature in a process using a locally stored key shared with the server or other device that encrypted the contextual data.

### BACKGROUND OF THE INVENTION

1. Field of the Invention

This invention relates to a method of generating and validating a voucher that is used to enable an end-user to obtain goods or services, such as a transportation tickets, car wash vouchers, vouchers for a cycle hire scheme, vouchers for a proof of purchase for a digital payment etc. The voucher may be printed, or may be shown on a display of eg a smartphone, or provided wirelessly, e.g. using NFC. The term ‘voucher’ should be expansively interpreted to cover any kind of ticket, receipt, invitation, acceptance or any other item or data, whether real or virtual, that enables an end-user to access, use, acquire, purchase or otherwise obtain goods or services.

2. Description of the Prior Art

The prior art falls into several categories, including:
1. Online validation—these require the system reading the codes to communicate with the system which generated them to check their validity. This is frequently impractical for all kinds of reasons, often relating to the cost or practicality of connectivity. Also, this may be time-consuming depending on the facilities available—it's not uncommon for mobile data-powered checks to take upwards of 30 seconds to a minute to verify.
2. Predefined codes—some operators generate random codes ahead of time. This has the drawback that they need to be shared somehow, and increases the risk that if the list is compromised, fraud becomes simple for any attacker. It also limits the volume of codes available due to the practicality of distributing lists, and has no scope for containing added data within codes.
3. Simple algorithms—some existing systems use a simple algorithm to generate a code for a given time period just based on the time and/or day. These are not used in the context of distributed codes and include the added risk that a simple algorithm is more open to reverse-engineering, and if that happens an attacker can generate their own codes on demand, with little risk of detection.

### SUMMARY OF THE INVENTION

A first aspect of the invention is a method of generating and validating a voucher that is used to enable an end-user to obtain goods or services; comprising the steps of:
(a) generating or acquiring contextual data that describes the goods or services and then encrypting that contextual data at a server or other device;
(b) generating a time code corresponding to or representing a span of time during which the voucher is valid and including or concatenating that time code with the contextual data, either before or after that contextual data has been encrypted;
(c) signing the contextual data and time code cryptographically using either a symmetric or asymmetric secret key or keys to generate a signature, in order to prove the origin issuer and time code at the point of generation;
(d) providing the contextual data and time code and/or the signature on a voucher, such as a printed voucher or as a virtual voucher shown on or provided using a computing device, such as a smartphone;
(e) validating the voucher offline at a validating system, without having on-line access to the server or other device that cryptographically signed the contextual data by means of comparing the signature in a process using a locally stored key shared with the server or other device that encrypted the contextual data.

Optional features of the invention include any one or more of the following:
the step of updating the voucher with an up-to-date time code, and including a time-frame either in the contextual data or the validating system to define for what period after time code generation and subsequent signing the voucher should be accepted.
the voucher is updated as regularly as the method of presentation allows, and which includes never updating the voucher.

We will describe three typical use cases in the following section; these can in broad terms be described as:
the validating system performs the following steps: extracting or re-generating the contextual data for a valid voucher without using the signed contextual data carried by the voucher itself and then (ii) signing that extracted or re-generated contextual data and then (iii) comparing that signature with the signature shown on or provided using the voucher.
the contextual data is signed with a private key and the validation system verifies the signature using a corresponding public key and compares that with pre-stored data.
the validation system comprises a human operator viewing the signature as represented in a human-readable form and comparing that with a previously supplied “model” signature that defines a valid voucher.

Other optional features include the following:
in the event that the presentation medium lacks the capacity to show both the signature, full contextual data and time code, the signature is shown on its own and if the signature of the contextual data generated by the validating system matches that shown on or provided by the voucher, then the goods or services defined by the contextual data are provided to the end-user.
the span of time for the time code is a time sufficient to account or compensate for drift or inaccuracy in the clock of the system that generates the time code and also the clock of the system that validates the code.
the validation system includes or accesses a time clock and validates the voucher only if the time code extracted from the voucher is presented within a pre-set time period as determined by that time clock.
the validation system extracts or re-generates the contextual data by using data in the clear and included on the voucher.
the validation system extracts or re-generates the contextual data by iterating through currently valid combinations.
a virtual voucher is provided on the computing device using a short-range wireless system, such as NFC.
the server generating the signature and the validation system that independently generates its own signature both use the same, shared symmetric encryption key or pair or asymmetric encryption keys.
the contextual data defines one or more of: a product code; a location code; metadata relating to the product or service being offered; identifying information regarding a customer; a code identifying the issuer or retailer.
the resulting data, comprising a signature, optionally including the contextual data, for a voucher is a numeric or alphanumeric code the end-user enters into a keypad at the validation system.
the resulting data for a voucher is a bar code, such as a 1D or 2D bar code that is scanned by the a scanner at the validation system.
the voucher is a transportation ticket, a car wash voucher, a voucher is for a cycle hire scheme, a voucher for a proof of purchase for a digital payment, a ticket for an event such as a concert, cinema or sporting event or other kind of event, a voucher to collect goods, such as food or drink or other items, ordered on-line.
the voucher is displayed by a smartphone app.
the voucher is displayed by a messaging app.

A second aspect is a system for generating and validating a voucher that is used to enable an end-user to obtain goods or services; the system including one or more computers each running one or more processors programmed to:
(a) generate or acquire contextual data that describes the goods or services and then encrypting that contextual data;
(b) generate a time code corresponding to or representing a span of time during which the voucher is valid and including or concatenating that time code with the contextual data, either before or after that contextual data has been encrypted;
(c) sign the contextual data and time code cryptographically using either a symmetric or asymmetric secret key or keys to generate a signature, in order to prove the origin issuer and time code at the point of generation;
(d) provide the contextual data and time code and/or the signature on a voucher, such as a printed voucher or as a virtual voucher shown on or provided using a computing device, such as a smartphone;
   and the system further includes a validating system including one or more computers each running one or more processors programmed to validate the voucher offline, without having on-line access to the server or other device that cryptographically signed the contextual data by means of comparing the signature in a process using a locally stored key shared with the part of the system that encrypted the contextual data and provided the voucher.

A third aspect is a voucher generated and validated using the method defined above or the system defined above.

An implementation of the invention is innovative due to the unique combination of features—no-one has previously combined:
Offline validation capability
Its ability to adapt from visual verification right up to machine-readable means like 2D barcodes or even contactless communication/NFC without varying the overall principle of operation
Its capability to include metadata about the product/service being redeemed within the code itself, i.e. ‘contextual data’.
Its use of timestamps and timeframes to keep the window of opportunity for misuse very small

### BRIEF DESCRIPTION OF THE FIGURES

The invention will be described with reference to the following:

FIG. 1: this shows the generic voucher generation mechanism;

FIG. 2: this is an example presentation of a generated code, displayed as both numeric and barcode for manual or scanned input;

FIG. 3: this shows an example presentation of a generated barcode with helpful timer to indicate how much availability time remains;

FIG. 4: this shows an example “flash pass” code, indicating bold presentation and graphical background. In practice, this could be animated and coloured to limit fraud.

### DETAILED DESCRIPTION

Specific implementations will now be described.

This invention, in one implementation, covers the concepts involved in generating and then redeeming voucher codes for pre-payment of goods and/or services such as car washing, where redemption is via a numeric (or alpha-numeric) code entered into a keypad or scanned by a device such as a barcode reader.

The system described offers clear benefits over randomly generated codes because the method of generation allows for codes to be mathematically validated without communication with the issuing party. In scenarios such as car washing, transportation and elsewhere, where connectivity between systems is never guaranteed, the ability to accurately validate even if off-line a pre-payment voucher quickly and reliably is essential.

Note that this document uses car washes and transport tickets as examples, referring to “pin pads” or “ticket machines” as the point of redemption. However, the concept is not limited to that application. Industries such as car washes, transport ticketing, fuel supply, food retail and others have a frequent need for secure codes which can be redeemed offline, and without the capability to communicate with the issuer. Further examples are given at the end of this document.

The system is flexible, adapting its possible implementation to the capabilities of the medium used, from simple visual checks to complex cryptographic checks. We anticipate that organisations making use of the system will choose the delivery and presentation media based on assessment of security risk, redemption value and complexity of implementation, balanced as a whole.

Generation Mechanism

When a customer purchases a voucher, they gain the ability to activate a “virtual” voucher for a period of (say) 15 minutes, after which it will expire. Time-based validation ensures the risk of fraud is minimal. Vouchers can be presented as alphanumeric or barcode visuals via smartphone applications, SMS messaging, paper printouts issued at a point of sale or any other means by which an alphanumeric code or barcode can be presented.

The complexity of the generation mechanism may vary depending on the means by which codes will be presented. The more data can be presented practically, the more information can be included during generation and the more secure anti-fraud measures can be.

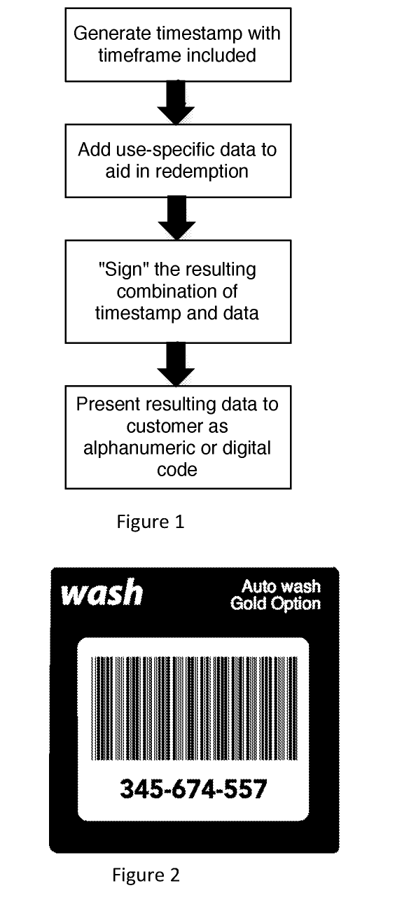

Generically, the generation process is shown in FIG. 1 as follows:
1. Generate a time code representing a span of time—e.g. a 15-minute block—in which the code will be valid. This accounts for possible drift in the clock of the system generating the code and the system validating it, but ensures that the code must be used within a predefined period.
2. Concatenate it with various ‘contextual’ data relevant to the product being redeemed. This may be a car wash location number and product code, or a transport ticket route number and passenger type. The number of items may vary depending on the usage and the data capacity of the presentation method. This data may be used after validation of the code to take further action or record the code's usage.
3. “Sign” the resulting data using an encryption method where the keys are pre-shared between the system/s generating and the system/s validating codes.
4. Present the resulting data as appropriate.

Redemption uses the signature to ensure that the data is intact:
1. Extract or re-generate the timestamp and contextual data. This may be via the data held in the clear, if the code has the capacity to do so, or by iterating through currently valid combinations.
2. Sign the extracted or re-generated data independently.
3. The code is valid if the signature, when compared, matches the signature of the code presented. The extracted or re-generated code can now be used to take further action; for example, starting an automatic car wash or allowing a customer to board a bus.

### Example

### Car Washing—See FIG. 2

In a scenario where car wash voucher codes need to be entered into a numeric keypad to activate a wash programme, the following will take place using the details of the product required and the location or group of locations the code will be valid for. The emphasis here is on brevity, since codes would present as numeric for manual input.

Each point of redemption may have a serial number and/or group codes, representing a grouping of locations. For example, a pad may belong to the “International Fuel Stations” group, the “Bob's Car Wash” group and a franchise owner's group, giving the ability to sell vouchers for all of those groups separately, with redemption of all three types on the same group of shared devices.
1. The timestamp is represented as the current time block since epoch (1970-01-01 00:00), GMT—for example, at 2012-12-11 13:02:23 the 15-minute block is 1505812
2. The use-specific contextual data is the serial number or group of locations the product is valid at, plus the product code (for example, a number from 1-6)
3. The signature is performed by generating a random “check code” (for example, 3 digits long), then creating a 6 digit hash of the data from 1 and 2 (see further in this document for an example hash function) with the check code appended
4. Present it for end-users to enter into the PIN pad

When the code is entered into the PIN pad, the pad will first check to ensure that it has not already been redeemed within the same time block, and that the timeframe is the current one. Otherwise, it will use the same hash algorithm to generate codes in the following order until it finds one that matches the one it's just been given:
its own serial number, plus each product code
each combination of group code and product code
both of the above for the previous time block, and again for the next time block (in case of clock drift either on the unit or the generating smartphone)

Since the same combination of inputs will produce the same output, two consecutive customers with the same choices within the same 15 minute block would have the same code. The “check code” prepended to the plaintext and also hashed into the code ensures an added level of entropy, as well as preventing tampering. This feature does not increase the computation required for validation, since it's just one more input to the same process as before.

Codes will be valid for a fixed period of time, with PIN pads and other redemption points equipped with a real-time clock and a list of the unit's serial number and group codes. These will be the foundation for code validation.

The nature of the codes and their limited time-span makes them ideal for delivery via smartphones where the above can be handled on the phone itself, although other methods such as paper tickets may also be suitable depending on the scenario.

Example Hashing Mechanism for Short Codes

After running tests on various hashing algorithms, code found online (at http://stackoverflow.com/questions/548158/fixed-length-numeric-hash-code-from-variable-length-string-in-c-sharp) has been found to be the most efficient. Benchmarks run on industry-standard industrial microcontrollers indicate that it gives a near-random distribution likely numerical ranges, and is sufficiently fast that even several hundred iterations can be performed within a tenth of a second.

An example C++ implementation follows.

```
int GetStableHash(char* s) {
  int MUST_BE_LESS_THAN = 1000000; // 8 decimal digits
  uint hash = 0;
  foreach (byte b in s)
{
  hash += b;
  hash += (hash << 10);
  hash \hat{ }= (hash >> 6);
}
  // final avalanche
hash += (hash << 3);
hash \hat{ }= (hash >> 11);
hash += (hash << 15) ;
    // helpfully we only want positive integer < MUST_BE_LESS_THAN
    // so simple truncate cast is ok if not perfect
    return (int)(hash % MUST_BE_LESS_THAN);
```

### Example

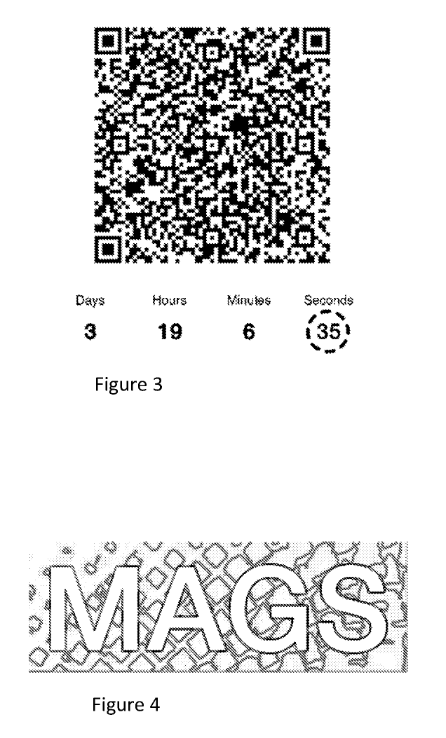

### Barcode Ticketing: See FIG. 3

In a scenario where bus tickets need to be issued and then redeemed via scanning a barcode via an in-vehicle ticket machine, the emphasis will be on the inclusion of more data to identify the ticket validity. Since 2D barcodes store more data, we can use a more complex signature mechanism to store information about the customer and product.
1. The timestamp is represented as the current time, GMT, plus an explicit timeframe in seconds—for example, “2012-12-11 13:02:23/300”. This gives customers a 5-minute window in which to use the ticket. If the code is generated on a digital device such as a smartphone, the timeframe may be much shorter (e.g. 30 seconds) and the whole code updated frequently (e.g. every 5 seconds) to increase security.
2. The use-specific contextual data may include the unique ticket code (e.g. “abc123”), the product name (e.g. “1-day Pass”), the passenger type (e.g. “Adult”) and the customer's account ID (e.g. “xzy789”).
3. The signature is performed using asymmetric encryption, where the private key is held on the generating system. If more than one system is involved in creating the code, the code may include multiple signatures. This is preferable to the “shared secret” used in the car wash example, as there is no risk to disclosure of public keys.
4. Display it for end-users to present to a barcode-scanning device.

When the code is scanned, the scanning device will first check to ensure that it has not already been redeemed within the same timeframe (preventing multiple passengers using the same barcode in the given timeframe), and that the timeframe is the current one.

Since 2D barcodes can hold more data than a 9-digit numeric code, the reading device can easily extract the various data fields rather than pre-generating all valid combinations in advance. The readers will be equipped with the public key corresponding to the generating system(s)' private key(s), and will thus verify that the included signature is correct.

The scanning device and/or bus driver can take further action based upon the result—ticket details can be shown on a screen, stored for later accounting, and the passenger prevented or allowed on-board the vehicle.

As with the previous example, the nature of the codes and their limited time-span makes them ideal for delivery via smartphones where the above can be handled on the phone itself, although other methods such as paper tickets may also be suitable depending on the scenario

### Example

### Travel “Flash Passes”—See FIG. 4

In a scenario where no electronic validation mechanism is available, the most basic implementation uses visual validation. Very little data can be stored within a visually checked code, since verification ideally needs to be quickly achievable by human eye.

The data specific to the code in this scenario is likely to be very simple—for example, a bus route code. Due to the codes having to be distributed to ticket inspectors ahead of time, the codes may be generic to a whole area.

The generation process is:
1. The timestamp is represented as the current time block since epoch (1970-01-01 00:00), GMT. The block size may, in this case, be quite large depending on the practicalities of distributing codes ahead of time—for example, 24 hours.
2. The use-specific contextual data is the route or area code.
3. The signature is performed using a pre-shared key, as with the first example.
4. The code is presented visually as an alphanumeric code.

If the presentation media is a smartphone or similar device, the code may be presented as a combination of the alphanumeric element plus a combination of coloured and/or moving/animated elements derived from the code itself.

Validation of the code will rely upon operators distributing codes to people performing validation ahead of time, via a method such as email or a website.

Validation Means

The system has been designed to be flexible and adaptable to a variety of verification options. Simple numeric codes may be easier to implement where only basic microcontrollers are available. Complex 2D barcodes with asymmetric signatures may be used where more capable computing devices are available, bringing the advantage of more data capacity alongside the security benefits. Visual flash passes may, despite the lower protection from fraud, be suited where equipment for electronic validation is not practical for some reason.

Implementation Notes
Encoding and signature hashing should be performed using a consistent character encoding. Mismatches between encodings could cause failed signature verification and thus refusal or inability to redeem a code.
To provide for sensible windows of validity, but to also allow for clock drift between system generating and the system validating codes, the suggested size of the time stamp timeframe is 5 minutes, so that checking for a given block and one either side gives a 10 minute window as a minimum.

Applications

These are a subset of possible applications for this invention:
Car wash vouchers
Transport tickets (bus, rail, tram, ferry, air etc.)
Cycle hire schemes, with codes used to unlock bicycles
Proof-of-purchase for digital payments buying physical goods, with codes used to collect purchases
Concert, sports or other event tickets
Collection of food or beverages ordered remotely and picked up in person from restaurants

The system will suit virtually any scenario where a secure proof-of-purchase is required but validation of that proof may not permit live checking against a “whitelist” of purchases.

1. A method of generating and validating a voucher that is used to enable an end-user to obtain goods or services; comprising the steps of:
a) generating or acquiring contextual data that describes the goods or services and then encrypting that contextual data at a server or other device;
b) generating a time code corresponding to or representing a span of time during which the voucher is valid and including or concatenating that time code with the contextual data, either before or after that contextual data has been encrypted;
c) signing the contextual data and time code cryptographically using either a symmetric or asymmetric secret key or keys to generate a signature, in order to prove the origin issuer and time code at the point of generation;
d) providing the contextual data and time code and/or the signature on a voucher, such as a printed voucher or as a virtual voucher shown on or provided using a computing device, such as a smartphone;
e) validating the voucher offline at a validating system, without having on-line access to the server or other device that cryptographically signed the contextual data by means of comparing the signature in a process using a locally stored key shared with the server or other device that encrypted the contextual data.

2. The method of claim 1 including the step of updating the voucher with an up-to-date time code, and including a time-frame either in the contextual data or the validating system to define for what period after time code generation and subsequent signing the voucher should be accepted.

3. The method of claim 2 in which the voucher is updated as regularly as the method of presentation allows, and which includes never updating the voucher.

4. The method of claim 1 in which the validating system performs the following steps: (i) extracting or re-generating the contextual data for a valid voucher without using the signed contextual data carried by the voucher itself and then (ii) signing that extracted or re-generated contextual data and then (iii) comparing that signature with the signature shown on or provided using the voucher.

5. The method of claim 1 in which the contextual data is signed with a private key and the validation system verifies the signature using a corresponding public key and compares that with pre-stored data.

6. The method of claim 1 in which the validation system comprises a human operator viewing the signature as represented in a human-readable form and comparing that with a previously supplied “model” signature that defines a valid voucher.

7. The method of claim 1 in which, in the event that the presentation medium lacks the capacity to show both the signature, full contextual data and time code, the signature is shown on its own and if the signature of the contextual data generated by the validating system, matches that shown on or provided by the voucher, then the goods or services defined by the contextual data are provided to the end-user.

8. The method of claim 1 in which the span of time for the time code is a time sufficient to account or compensate for drift or inaccuracy in the clock of the system that generates the time code and also the clock of the system that validates the code.

9. The method of claim 1 in which the validation system includes or accesses a time clock and validates the voucher only if the time code extracted from the voucher is presented within a pre-set time period as determined by that time clock.

10. The method of claim 1 in which the validation system extracts or re-generates the contextual data by using data in the clear and included on the voucher.

11. The method of claim 1 in which the validation system extracts or re-generates the contextual data by iterating through currently valid combinations.

12. The method of claim 1 in which a virtual voucher is provided on the computing device using a short-range wireless system, such as NFC.

13. The method of claim 1 in which the server generating the signature and the validation system that independently generates its own signature both use the same, shared symmetric encryption key or pair or asymmetric encryption keys.

14. The method of claim 1 in which the contextual data defines one or more of: a product code; a location code; metadata relating to the product or service being offered; identifying information regarding a customer; a code identifying the issuer or retailer.

15. The method of claim 1 in which the resulting data, comprising a signature, optionally including the contextual data, for a voucher is a numeric or alphanumeric code the end-user enters into a keypad at the validation system.

16. The method of claim 1 in which the resulting data for a voucher is a bar code, such, as a 1D or 2D bar code that is scanned by the a scanner at the validation system.

17. The method of claim 1 in which the voucher is a transportation ticket.

18. The method of claim 1 in which the voucher is a car wash voucher.

19. The method of claim 1 in which the voucher is for a cycle hire scheme.

20. The method of claim 1 in which the voucher is for a proof of purchase for a digital payment.

21. The method of claim 1 in which the voucher is a ticket for an event, such as a concert, cinema or sporting event or other kind of event.

22. The method of claim 1 in which the voucher is to collect goods, such as food or drink or other items, ordered on-line.

23. The method of claim 1 in which the voucher is displayed by a smartphone app.

24. The method of claim 1 in which the voucher is displayed by a messaging app.

25. A system for generating and validating a voucher that is used to enable an end-user to obtain goods or services; the system including one or more computers each running one or more processors programmed to:
a) generate or acquire contextual data that describes the goods or services and then encrypting that contextual data;
b) generate a time code corresponding to or representing a span of time during which the voucher is valid and including or concatenating that time code with the contextual data, either before or after that contextual data has been encrypted;
c) sign the contextual data and time code cryptographically using either a symmetric or asymmetric secret key or keys to generate a signature, in order to prove the origin issuer and time code at the point of generation;
d) provide the contextual data and time code and/or the signature on a voucher, such as a printed voucher or as a virtual voucher shown on or provided using a computing device, such as a smartphone;
and the system further includes a validating system including one or more computers each running one or more processors programmed to validate the voucher offline, without having on-line access to the server or other device that cryptographically signed the contextual data by means of comparing the signature in a process using a locally stored key shared with the part of the system that encrypted the contextual data and provided the voucher.

26. A voucher generated and validated using a method of generating and validating the voucher that is used to enable a end-user to obtain goods or services; the method comprising the steps of:
(a) generating or acquiring contextual data that describes the goods or services and then encrypting the contextual data at a server or other device;
(b) generating a time code corresponding to or representing a span of time during which the voucher is valid and including or concatenating that time code with the contextual data, either before or after that contextual data has been encrypted;
(c) signing the contextual data and time code cryptographically using either a symmetric or asymmetric secret key or keys to generate a signature, in order to prove the origin issuer and time code at the point of generation;
(d) providing the contextual data and time code and/or the signature on a voucher such as a printed voucher or as a virtual voucher shown on or provided using a computing device, such as a smartphone;
(e) validating the voucher offline at a validating system, without having on-line access to the server or other devices that cryptographically signed the contextual data by means of comparing the signature in a process using a locally stored key shared with the server or other device that encrypted the contextual data.
